(19) United States
(12) Patent Application Publication
(10) Pub. No.: US 2007/0256023 A1
(43) Pub. Date: Nov. 1, 2007

(54) Demonstration scripting using random-access frame presentation

(75) Inventors: Christopher W. Noessel, San Francisco, CA (US); Stephen T. Kelly, Redmond, WA (US); Steve E. Weil, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/413,477

(22) Filed: Apr. 28, 2006

(51) Int. Cl. G06F 17/00

(52) U.S. Cl. 715/753

(57) ABSTRACT

A control framework allows a presenter to change the executable order of the graphical presentation either dynamically or using a scripted order without an understanding of the underlying presentation framework. A data file created by the presenter external to the graphical presentation associates a unique identifier with each frame in the graphical presentation. Identifiers may be arranged in groups to logically associate frames for presentation together. Input commands from the presenter may be used to dynamically jump between prior and next frames in a group or between groups of frames. The control framework may also smoothly transition the position of actors between arbitrary frames in the overall presentation.

### BACKGROUND OF THE INVENTION

Certain computer software products provide tools for creating animated graphical presentations. Such graphical presentations may be organized using the concept of storyboards created using a metaphor that is analogous to actors in theater. Macromedia Director is an example of such a product that follows this metaphor. The ultimate presentation involves “actors” placed on a “stage” at certain points during a timeline. The timeline is broken down into “scenes,” where a scene represents some logical piece of the overall presentation. The actual graphical presentation is composed of a series of “frames,” similar in concept to frames of film that capture an instant of action. Each scene is thus composed of a set of the frames.

Generally each scene will comprise a fixed set of actors that will be on the stage during the scene undertaking some simple interaction. For example, a presentation providing computer instruction may depict a document being dragged onto a folder. In this example, the document and the folder are both aeters on the stage. A particular set of frames are logically grouped together to create the scene.

The number of frames in a presentation can be quite large and the rules dictating the actions of actors in each frame or over a sequence of frames can be quite complex. In some implementations there may be hundreds of sprites used in the total presentation and many of them are always on the stage. Often many of these sprites may simply represent a background while only a few are in action within any particular frame.

The information included in this Background section of the specification, including any references cited herein and any description or discussion thereof, is included for technical reference purposes only and is not to be regarded subject matter by which the scope of the invention is to be bound.

### SUMMARY

The technology described herein is provided as a control framework that interacts with a graphical presentation file and a presentation framework implementing the graphical presentation. The purpose of the control framework is to allow a presenter to change the executable order of the graphical presentation without an understanding of the underlying presentation framework. The control framework allows the presenter to either script an alternate presentation order, dynamically alter the order of the presentation using input commands, or both.

The control framework calls upon information in a data file created by the presenter external to the graphical presentation. At a base level, the data file associates a unique descriptor or identifier with each frame in the graphical presentation. Using the descriptors, the frames may further be arranged by the presenter to change the sequence and to create groups of frames that should be presented together without interruption. Input commands from the presenter, for example, arrow keys or page up/page down keys, may be used to dynamically jump between prior and next frames within a group or between groups of frames. An alternate presentation order may be created by the presenter and represented as a path in the data file. The path element defines a sequence of such group descriptors resulting in an arrangement of the frame order different from the original executable order of the graphical presentation as originally authored.

Additionally, the control framework may be implemented to smoothly transition the position of actors between arbitrary frames in the overall presentation. For example, when dynamically transitioning between frames, actors common to both frames may have been manually moved by the presenter to arbitrary locations on the stage. They are no longer in the position the presentation framework expects them to be in at the beginning of the frame to which it is transitioning. The control framework may account for these different positions and smoothly move the actors from a prior location in the previous frame to a starting location in the next chosen frame to make the transition appear smooth.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1A is a schematic illustration of the final frame of a prior scene in a presentation including several actors on a stage.

FIG. 1B is a schematic illustration of a transition operation wherein a sprite is relocated from its position on the stage in the prior scene to a starting position on the stage in the first frame of a selected next scene.

FIG. 1C is a schematic illustration of the selected next scene in which sprites are moved on the stage as part of the execution of the scene in the presentation.

FIG. 2 is a schematic illustration of functionality to skip a scene.

FIG. 3 is a flow diagram of a dynamic alteration to the sequence of frame presented in a graphical presentation.

FIG. 4 is a flow diagram of one implementation of a series of operations for dynamically advancing or retreating through groups of frames in a presentation.

FIG. 5 is a flow diagram of one implementation of a series of operations for dynamically accessing frames or scenes in a presentation.

FIG. 6 is a flow diagram of one implementation of a series of operations for relocating a sprite from one position on a stage to another before the start of a scene.

FIG. 7 is a schematic diagram of an exemplary computer system for implementing dynamic frame and scene access operations.

### DETAILED DESCRIPTION OF THE INVENTION

Software programs exist for creating animated graphical presentations for various purposes, e.g., software mockups, training demos, animated cartoons, and photorealistic computer generated image films. The graphical presentations may be saved as stand-alone audio-video files and output for publication for example, on compact disks, digital video disks, or as streaming media as part of an Internet web site or web application. These software programs may be quite sophisticated.

In an attempt to reduce this complexity, especially in terms of building the user interface or “presentation” portions of an animated graphical presentation, presentation frameworks, i.e., libraries or toolkits of prepared functions or operations, have been developed. A presentation framework may be a part of the presentation creation software program or it may be a toolkit that provides additional features to the primary software program. The term “graphical presentation” is used herein to refer to animated graphical presentations created by a software program tool as distinguished from the term “presentation,” which is used herein to refer to a speech or instructional session by a presenter that may include a graphical presentation as part of the session to help convey information to an audience.

In one implementation, a presentation framework may arrange components of the graphical presentation in the paradigm of a stage presentation. An exemplary software program implementing such a presentation framework is Macromedia Director. Such a presentation framework may be used to animate instances of graphic “actors” (called “sprites”) designed by a user or “director.” Graphical presentations may be segmented into discrete scenes. A scene is a collection of frames. Instructions in the frame define the actions sprites may engage in during the frame.

The instructions are generally specified using tools in the presentation framework or written in a form of or similar to a computer programming language. For example, Macromedia Director provides a scripting language called Lingo that allows for handling various events that occur during the graphical presentation. An action may take place in a single frame or the action may be spread across several frames to occur over a period of time. Thus, the presentation framework provides for a combination of actors and a stage within a frame, and a set of instructions within or across a group of frames that dictate the action of the actors on the stage.

User input, for example, keystrokes or mouse clicks, may also be recognized by the presentation framework to control the course of the presentation. For example, a user may select a certain keystroke to pause the graphic presentation and another keystroke to restart the presentation. This functionality allows a user of the graphic presentation some control over the course of a live presentation to an audience in real time.

The presentation creation program may also be used to create graphical presentations that interface with the computer operating system to control operations of the computer, rather than merely displaying graphics developed in the presentation creation program, as part of the graphic presentation. The graphical presentation may include commands that drive or automate the operating system or other applications, or render other media. For example, some graphic presentations may be designed to include instructions that cause the operating system to generate sounds or play a related video file.

Graphical presentations can also be designed to control the operation of the user interface (UI) of the operating system. As discussed later herein, instructions for controlling frame transition events and performing functions upon recognition of keystroke events are of particular relevance to the present technology. In addition, the graphical presentation may, for example, open or close command or file search windows or control the movement or position of the mouse cursor. Thus, instead of a user having to create a separate graphic representation of a window interface or a mouse cursor for use in the graphical presentation, the presentation creation program takes advantage of the application program interface (API) for the elements of the UI and makes those elements available to the director in the creation of a graphical presentation.

For example, in graphical presentations designed for computer software training, the mouse cursor is frequently involved in driving the action across the frames in a scene. The presentation framework can interface with the UI API to move the mouse cursor as part of the graphical presentation; the mouse cursor is not being directed by a user. In the context of the prior example, the graphical presentation might involve the mouse cursor dragging a document to a folder. This generally means that fixed start and end points are defined as part of the presentation framework for an animated scene.

Alternately, a mouse sprite may be created and defined as part of the presentation framework for an animated scene. In addition the animated mouse sprite may also be moved on a stage based on physical mouse movement by a user rather than invoking the UI API to represent the mouse cursor. Other standard graphics and functions mimicking UI functionality may also be created and animated within the presentation framework if desired.

Graphical presentations are often designed to pause upon the completion of each scene or a series of related scenes. This allows a presenter some level of control over the presentation and provides an opportunity for the presenter to interact with the audience, for example, to elaborate on the discrete point represented by the scene, answer questions from the audience about the scene, or lead a discussion about the material presented in the scene before continuing the graphical presentation.

As part of the interaction with the audience, however, the presenter may want to move the mouse cursor around to point at or highlight other areas of the presentation, or to activate other aspects of the scene or UI. Recall that a mouse cursor used as an actor in a graphical presentation may be implemented by controlling the UI API. Thus, the mouse cursor appearing on the stage at the end of a scene may be controlled by the presenter once the scene is completed by physically moving the mouse as usual. Other actors or sprites on the stage may be similarly manipulated by the presenter between scenes in the graphical presentation.

One problem that this inter-scene control of actors creates is that the actors may wind up in positions on the stage that are different from the position at the end of the prior scene. In many presentations, the same actors are involved in the action in successive scenes. Thus when the scenes are created in the presentation creation program, an actor is generally placed in the same position in the first frame of the next scene as the actor was in the last frame of the prior scene. This makes the graphical presentation appear fluid in the animation of the actors on the stage.

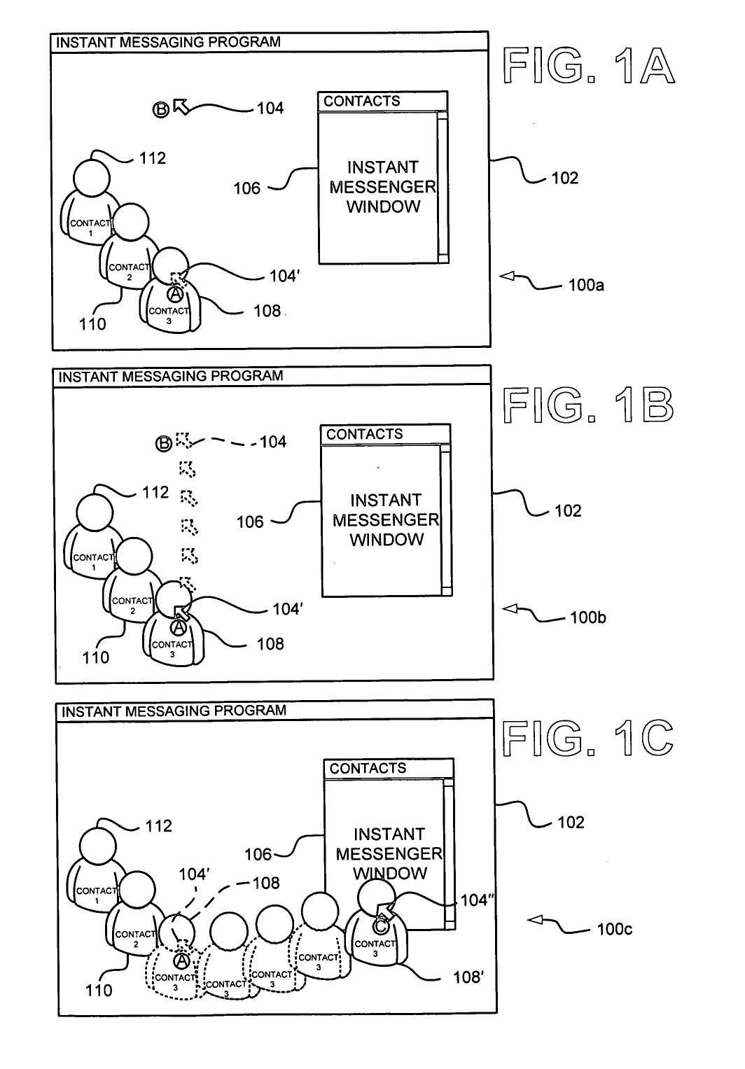

This manual interaction with actors during a pause between scenes in a graphical presentation is depicted in FIGS. 1A-1C. FIG. 1A depicts a final frame 100 of a scene of a presentation for demonstrating the functionality of an instant messaging (IM) program. The frame 100 is composed of a stage 102 in the form of a GUI window for the IM program. Several actors or sprites appear on the stage 102. These actors include a mouse cursor 104, an instant messenger window 106, and a plurality of contact avatars 108, 110, 112.

The instant messenger window 106 represents any standard IM interface with a listing of contacts and conversations. The contact avatars 108, 110, 112 in the lower left represent people and associated contact information that the user might want to interact with in some way, e.g., via e-mail, IM, or Internet telephony. At the conclusion of the scene, the presenter may drag the mouse cursor 104 around the IM window stage to point to or emphasize various items of interest, or to act on any of the objects on the screen.

Note that the mouse cursor 104 at point B was previously an actor in the graphical presentation and at the end of the scene the mouse cursor 104 was positioned at point A over a first contact avatar 108 as indicated by the phantom mouse cursor 104′. Therefore, if the presenter does move the mouse cursor 104 about the stage 102 between scenes, the mouse cursor 104 may be in any arbitrary position on the screen at the beginning of the next scene.

Continuing with this example, the next scene 100c of the graphical presentation depicted in FIG. 1C illustrates the placement of a contact avatar 108′ onto the instant messenger window 106 to initiate a conversation with the person represented by the contact avatar 108′. The playback of the next scene 100c is initiated by the presenter, for example, by striking a key on a keyboard, when the time is appropriate. For the next scene to begin, however, the mouse cursor 104 at point B in FIG. 1A needs to be relocated to its starting position at point A.

To prevent a visual jump in the location of the mouse cursor 104, it may be desirable to seamlessly transition the mouse cursor 104 to its position at the first frame of the next scene, i.e., at point A on the contact avatar 108 as shown in FIG. 1B. The frame 100b in FIG. 1B is still the final frame of the prior scene with the IM program window as the stage 102. The contact pawns 108, 110, 112 remain in their initial positions on the stage 102. When the presenter initiates the next scene, a control framework not associated with any particular frame or scene may be implemented to fluidly transition the mouse cursor 104 at any arbitrary position B to a start position A where the mouse cursor 104′ is depicted. The fluid movement of the mouse cursor 104, 104′ in FIG. 1B between positions B and A is indicated by the mouse cursor positions drawn in phantom between points B and A.

FIG. 1C then depicts the next scene 100c of the graphical presentation. The presentation framework of the next scene 100c depicts the mouse cursor 104′ dragging the first avatar 108 from position A across the stage 102 to the instant messaging window 106. The other contact avatars 110, 112 remain in their prior positions on the stage 102. The fluid movement from position A to relocate the first contact pawn 108′ and the mouse cursor 104″ at position C in the instant messenger window 106 is indicated by the pawn and mouse cursor positions drawn in phantom between point A and point C.

The transition of position of the mouse cursor between the two scenes of FIG. 1A and FIG. 1C described in the above example with respect to FIG. 1B may be applied to actors on the stage other than the mouse cursor, i.e., to any sprite in a frame.

As described above, multiple frames in a graphical presentation might logically be grouped together into a scene. During the course of a presentation, a presenter may want to alter the prearranged sequence of the graphical presentation. For example, a presenter may desire to skip through a scene that is inappropriate for a particular audience or may want to rapidly jump backwards to a scene previously played to illustrate a point. However, graphical presentations prepared in presentation creation programs are sequenced at the time of creation and often output for play as a self-contained executable file. The predefined executable frame order or sequence of a graphical presentation may not be varied without opening the graphical presentation in the presentation creation program and revising the instructions to change the order of scenes. Thus, other than preprogrammed pauses between scenes or preprogrammed choices for alternative sequences, the presenter has no dynamic control over a graphical presentation.

In one implementation of the technology described herein, a control framework may be overlaid on the graphic presentation and instantiated to provide flexibility to a presenter to easily move between frames or scenes of a graphical presentation during the course of a presentation. For example, rather than moving through every frame that logically represents a scene, the technology may allow the presenter to use a single keystroke to jump from one logical scene forward or backward to the next or previous scene. In another implementation, the technology allows a presenter to dynamically reorder and select among scenes or other groups of frames in a graphical presentation without need to recode the underlying graphical presentation in the presentation creation program.

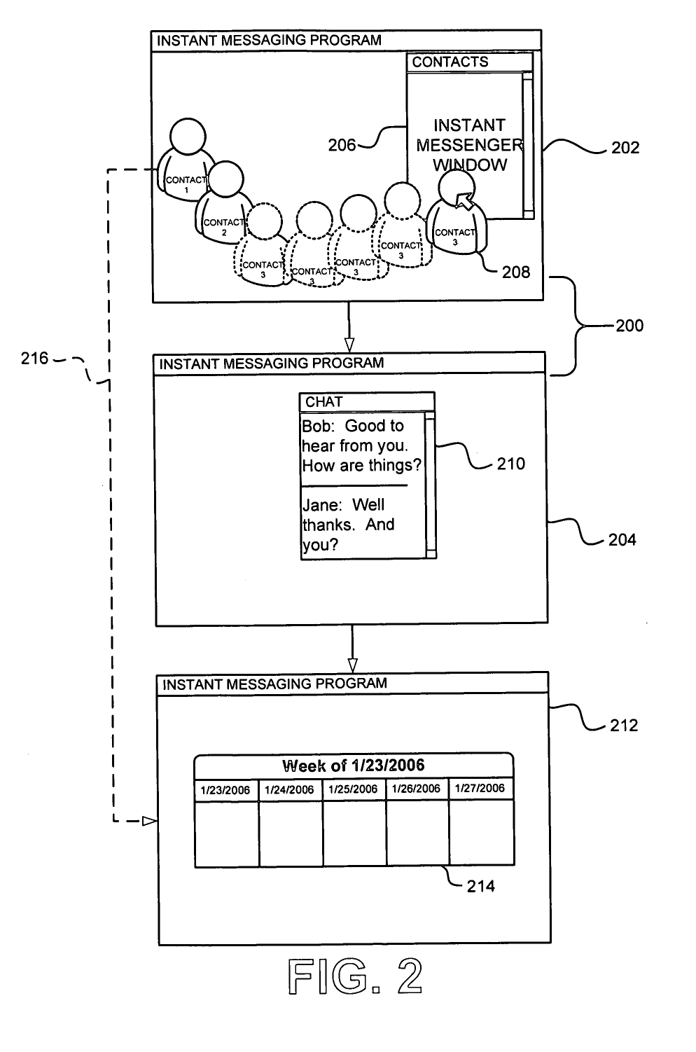

In FIG. 2, an exemplary graphical presentation may have several scenes with frames implementing a series of images. In a first part 202 of a first scene 200, an icon 208 is dragged onto an instant messaging window 206. In a second part 204 of the first scene 200, an instant messaging session 210 is entered and some dialog is exchanged. After the instant messaging session 210 of the first scene 200, a second scene 212 is initiated in which an entry is made in a calendar 214. The presenter may decide to skip the instant messaging session 210 in the second part 204 of the first scene 200 as indicated by the dashed line 216 between the first part 202 of the first scene 200 and the second scene 212. The technology may be implemented to allow the presenter to press the “page down” key on the keyboard of the computer running the graphical presentation at any point during the scene and the graphical presentation gracefully moves to the first frame of the next logical scene, skipping intermediary frames.

The control framework may be understood as a “plug-in” program that interfaces with and provides additional functionality to a presentation viewer program. Alternatively, it could be built-in to the presentation authoring or viewing program. The presentation viewer program may merely be the presentation creation program that further includes viewing capabilities or it may be a separate software program limited in general capability to merely presenting the graphical presentation.

In order to implement the dynamic restructuring of a graphical presentation, an external presentation order file may be structured to identify a group of frames as belonging to a particular scene. Additional instructions outside the presentation framework of the scene that invoke frame transition processing elements of the graphical presentation player or viewer software, for example, a direct frame access command, override the graphical presentation instructions and cause the frame transition processor to find the next or prior starting point of a scene and move the presentation automatically to that point.

In another example, the presenter may wish to perform the graphical presentation in a different order than it is originally scripted. For example, the presenter may wish to reorder the scenes or delete scenes altogether. Rather than having to be an expert in the use of the presentation creation program to recode the presentation framework to modify the order of the graphical presentation, the external presentation order data file may include definitions for alternate scene orders as well. Alternatively, the control framework might include a user interface to perform these same actions visually. The UI may or may not create an intermediate file to store the results.

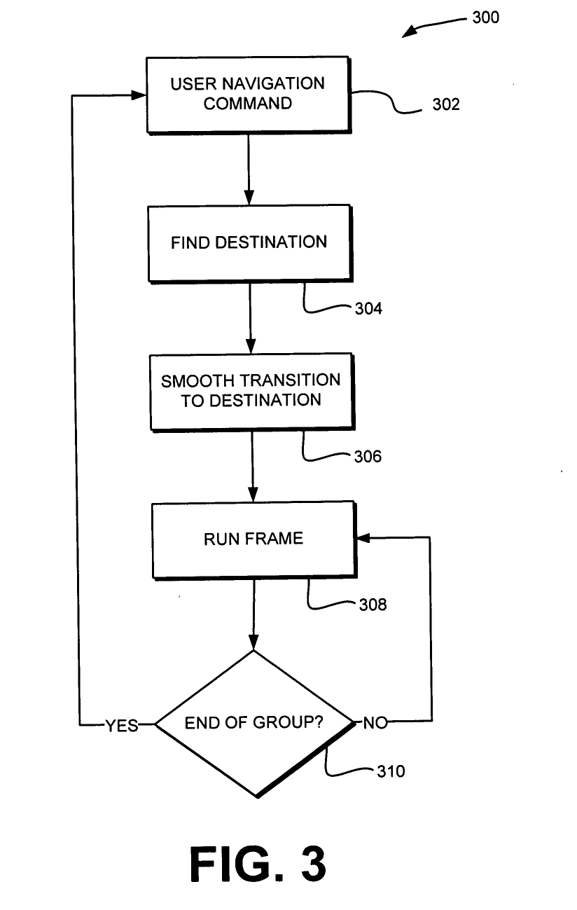

FIG. 3 depicts a general process 300 undertaken by the control framework upon receipt of a command by a presenter to navigate or advance through the graphical presentation. Upon receipt of a navigation command operation 302 by a presenter in the UI, for example, a spacebar or page up or page down key, the control framework performs a finding operation 304 in which a new frame destination is determined based upon the entered navigation command and navigation data in the data order file. The new frame destination may be in a group of frames in advance of or following the present group of frames.

Once the destination is found, the control framework performs a transition operation 306 in which the transition between the prior frame and the frame destination is smoothed. When performing the transition operation 306, the control framework determines the positions of the sprites on the stage in the prior frame and the positions of common sprites in the destination frame and smoothly animates movement of the sprites to positions in the destination frame if different from the prior frame.

Once any relocation of sprites is completed, the control framework returns control of the graphical presentation to the presentation framework, which performs a run frame operation 308 to present the destination frame. Upon presentation of each frame, the control framework monitors the data attributes associated with each frame to determine whether the frame is part of a common grouping of frames, for example, a scene. A query operation 310 determines whether the frame is at the end of a group of frames. If the frame is not the last frame in the group, the presentation framework returns to the run frames operation 308 and continues to play the presentation. If the query operation 310 determines the frame is the last frame in a group, the control framework pauses the graphical presentation to await a further user navigation command operation 302.

In one implementation, extensible mark-up language (XML) may be used for the presentation order data file. XML elements may be used to label frames, define groups of frames as scenes or other units, and identify attributes of frames or scenes to provide additional functionality. In an exemplary form, a root element “Presentation” may be defined by the following child elements: Frames, Scenes, Gears, and Paths. Each of these elements may include one or more additional elements or attributes.

The Frames element is used to uniquely identify each frame within the presentation framework. Each frame may be given a logical name and/or an identifier attribute, e.g., the identifier may be a frame number 1-n as defined in Macromedia Director. For example, in Macromedia Director the frame access command, “go ‘frame,’” transitions the graphical presentation from the present frame to the frame identified by the number that is used as the ‘frame’ argument in the command “go.”

Scenes are simply sets of contiguous frames through which a graphical presentation will automatically advance when played. A Scene may be considered a logical grouping of frames into a sequence of frames for which there should be no pause between. A Scene may be a single frame or a group of sequential frames. When the control framework is implemented, as each frame in the Scene completes, an automatic transition to the next frame in the Scene occurs. It should be apparent that other divisions and groupings of frames may also be defined to provide additional levels of control. For example, an “Act” division could be defined that consists of a sequential group of Scenes.

The concept embodied in a Gear is that of moving through the presentation at different rates. A Gear has associated forward and reverse actions initiated by the user. For example, the “page down” may be selected by a user to cause the presentation framework to invoke a related gear. A Gear may cause the presentation to skip, for example, a single frame, a group of frames collected as a Scene, or a group of Scenes depending upon the “speed” of the selected Gear.

A Path is an ordered collection of Scenes that define the order of frames or scenes in a graphical presentation. There should be only one active Path. An active path identifier variable in the presentation order file may be used to define the active Path or the user may choose from among several available, predefined Path elements at the start of the presentation.

During the presentation, the presenter may wish to vary the pace based on the audience reaction. For example, in one implementation of a control framework, if the user presses an advance key, e.g., the “spacebar,” then a transition to the next Scene occurs. On the other hand, if the user presses a “skip forward” key, e.g. “page down,” then a transition to the next Scene in the Path with an appropriate “skip” identifier occurs. In this way, the graphic presentation may be configured to skip through one or more Scenes before returning to a display of the graphical presentation. Beyond scenes, additional groupings as suggested above could be added to provide more control over the amount of detail shown in the presentation. Further, in addition to moving forward, there may be controls to allow the presenter to move backwards though the presentation in varying steps.

A template for an exemplary XML presentation order file defining frames and Scenes is set forth below. This file is written for an implementation wherein Macromedia Director was used to create the presentation framework for the graphical presentation.

```
<Presentation>
  <Frames>
    <Frame name=“frame name”
frameNum=“Director_frame_number”>
  </Frames>
  <Scenes>
    <Scene name=“scene_name”>
      <Frame frameName=“frame_name”/>
    </Scene>
  </Scenes>
  <Gears>
    <Gear name=“gear_name” forwardEvent=“event_type”
reverseEvent=“event_type”/>
  </Gears>
  <Paths>
    <Path name=“path_name”>
      <SceneReference gear name=“status”
sceneName=“scene_name”>
        <GearReference gearName=“gear_name”/>
      </SceneReference>
    </Path>
  </Paths>
<Presentation>
```

As indicated, several of the elements in the presentation order file may contain additional elements and attributes. In the exemplary Presentation element above, additional attributes include the following: name (for each further element Frame, Scene, Gear, and Path), frameNum, frameName, forwardEvent, reverseEvent, and sceneName, the data held by each of which is described below.

The “name” attribute associated with the Frame element holds an identifier value generically denominated above as “frame_name.” The “frame_name” is a simple name for the Frame and may be used to uniquely reference this Frame from other elements in the file. For example the name of the first Frame might be “Introduction.”

The “frameNum” attribute associated with the Frame element holds an identifier value generically denominated above as “Director_frame_number.” The Macromedia Director program assigns each frame a simple integer number. The “Director_frame_number” is the number defining the frame in Macromedia Director. An API in Lingo allows a presentation author to instruct a graphical presentation created in Macromedia Director to jump to a particular frame number.

The “name” attribute associated with the “Scene” element holds an identifier value generically denominated above as “scene_name.” The “scene_name” data is simply the name of a Scene. The “frameName” attribute associated with the Frame element within a Scene element indicates a previously defined “frame_name” that is part of the Scene.

The “name” attribute associated with the “Gear” element holds an identifier generically denominated above as “gear_name.” The “gear_name” is simply the name given to a Gear. The Gear element contains additional attributes of “forwardEvent” and “reverseEvent,” each of which may hold “event_type” information related to the particular “gear_name.” The “event_type” may be a UI command from a user or other navigational cue.

The “name” attribute associated with the “Path” element holds an identifier value generically denominated above as “path_name.” The “path_name” is simply the name given to a Path. This could, for example, be presented to a user as a list of possible Path elements when the presentation framework is started. The user chooses a Path to run for a particular graphical presentation.

The SceneReference element holds an optional reference to a “status” of a “gear_name,” in particular whether the “gear_name” is “on.” One or more “gear_names” may be listed here with the value “on.” If a Gear is not listed, that Gear is assumed to be “off” for this Scene. The “sceneName” attribute associated with the SceneReference element within a Path element identifies a previously defined “scene_name” that is part of the Path.

The use of the Gear element allows a presentation to progress at different speeds. In one example, a Scene may be considered a collection or group of one or more sequential frames. In the exemplary XML template shown above, the Gear element may provide two “speeds” at which a user can navigate through the frames in a graphical presentation. The first speed may be to skip to a next or previous Scene. The second speed may be to skip to a later or prior Scene, which may or may not be the immediate next or previous scene.

For example, if the user presses an “event_type” advance key tied to a “skip scene” designation, e.g., “page down” as opposed to “space,” which may instead be tied to an immediate next Scene designation, the presentation may automatically advance to the next Scene with a skip scene tag regardless of in the number of intermediate Scenes. There is an ordering implicit in the sequence in which frame names are encountered in a Scene. Of the frames comprising a Scene, the frame nearest the top of the Path is considered the first frame of the Scene.

The following is a sample XML file populated with exemplary values and attributes according to the presentation order template described above.

```
<Presentation>
  <Frames>
    <Frame name=“Introduction” frameNum=“1”>
    <Frame name=“KimStartsMeeting” frameNum=“2”/>
    <Frame name=“KimSharesInformation” frameNum=“3”/>
    <Frame name=“KimInvitesAlex” frameNum=“4”/>
    <Frame name=“StartReport” frameNum=“5”/>
    <Frame name=“OpenWord” frameNum=“6”/>
    <Frame name=“TypeReportInWord” frameNum=“7”/>
    . . .
  </Frames>
  <Scenes>
    <Scene name=“Intro”>
      <Frame frameName=“Introduction”/>
    </Scene>
    <Scene name=“MeetingStart”>
      <Frame frameName=“KimStartsMeeting”/>
      <Frame frameName=“KimSharesInformation”/>
      <Frame frameName=“KimInvitesAlex”/>
    </Scene>
    <Scene name=“PrepareReport”>
      <Frame frameName=“StartReport”/>
      <Frame frameName=“OpenWord”/>
      <Frame frameName=“TypeReportInWord”/>
    </Scene>
    . . .
  </Scenes>
  <Gears>
    <Gear name=“nextscene” forwardEvent=“spacebar”
reverseEvent=”backspace”/>
    <Gear name=“skipscene” forwardEvent=“pagedown”
reverseEvent=“pageup”/>
  </Gears>
  <Paths>
    <Path name=“Craigs Presentation”>
      <SceneReference nextscene=“on” skipscene=“on”
sceneName=“Intro”>
        <GearReference gearName=“nextscene”/>
        <GearReference gearName=“skipscene”/>
      </SceneReference>
      <SceneReference nextscene=“on”
sceneName=“MeetingStart”>
        <GearReference gearName=“nextscene”/>
      </SceneReference>
      <SceneReference nextscene=“on” skipscene=“on”
sceneName=“PrepareReport”>
        <GearReference gearName=“nextscene”/>
        <GearReference gearName=“skipscene”/>
      </SceneReference>
    </Path>
  </Paths>
</Presentation>
```

As shown above, the Frame numbered 1 in the presentation creation program is named “Introduction.” The Frames numbered 2, 3, and 4 in the presentation creation program are named “KimStartsMeeting,” “KimSharesInformation,” and “KimlnvitesAlex,” respectively. The Frames numbered 5, 6, and 7 in the presentation creation program are named “StartReport,” OpenWord,” and TypeReportInWord,” respectively. As indicated, other numbered frames may also be individually named if desired. Naming the frames abstracts the user, i.e. the person reordering the presentation who may not know anything about the framework, from having to understand potentially arcane frame designators in the framework. It should be apparent that assigning names to frames may be convenient, but unnecessary as identification by frame number may suffice.

Next, three Scenes of grouped frames are defined. The “Intro” Scene contains only one frame, the frame named “Introduction.” However, the “Meeting Start” Scene contains three frames named “Kim Starts Meeting,” KimSharesInformation,” and “KimInvitesAlex.” The “PrepareReport” Scene also contains three frames named “StartReport,” OpenWord,” and TypeReportInWord.” As indicated, additional Scenes may be defined from among additional frames or from different combinations of frames.

Note that two name attributes are defined in the Gear element. The first name attribute is identified as “nextscene,” which is associated with a “forwardEvent” attribute keyed on a “spacebar” input by a user and a “reverseEvent” attribute keyed on a “backspace” input. The second name attribute is identified as “skipscene,” which is associated with a “forwardEvent” attribute keyed on a “pagedown” input by a user and a “reverseEvent” attribute keyed on a “pageup” input. These Gears may be used to move through the presentation at two different “speeds.”

The Path named “Craigs Presentation” as shown is composed of an element identified as SceneReference, which provides the control instructions for advancement through each defined Scene upon reception of a user navigation command. None, one, or both of the Gear name attributes, i.e., nextscene and skipscene, may be associated with each of the Scene names. If a Gear name attribute is set to “on,” this indicates that an associated forwardEvent or reverseEvent will cause the presentation to play that particular group.

For example, to initiate the “Intro” Scene, Craig may select either the spacebar or the pagedown key. If during the presentation of the frames in the “Intro” Scene Craig selects the spacebar, the presentation will skip the remaining frames in the “Intro” Scene and begin playing the frames in the “MeetingStart” Scene. Alternately, if the backspace key is pressed, the presentation would skip back to the first frame of the “Intro” Scene. However, if Craig selects the pagedown key, the presentation will skip the remaining frames in the “Intro” Scene, as well as all the frames in the “MeetingStart” Scene, and advance to the first frame of the “PrepareReport” Scene, i.e., a Scene is skipped.

In this manner, multiple “speeds” can be implemented with which to proceed through graphical presentation. Note, it makes little sense to have both nextscene and skipscene Gears associated with every Scene. Also, note that a Gear need not be associated with a particular Scene at all. In this instance, if a user presses any navigation key, the presentation will simply skip that Scene and begin playing the next successive Scene with a Gear switched “on.” Additional Paths may be defined from among additional Scenes or from additional combinations or orders of Scenes.

Once a presentation order file is created, Frames have been identified, and Scenes, Gears, and Paths have been defined, a control framework may use the information about the frames in the graphical presentation stored in the presentation order file to provide dynamic control of the graphical presentation by a presenter.

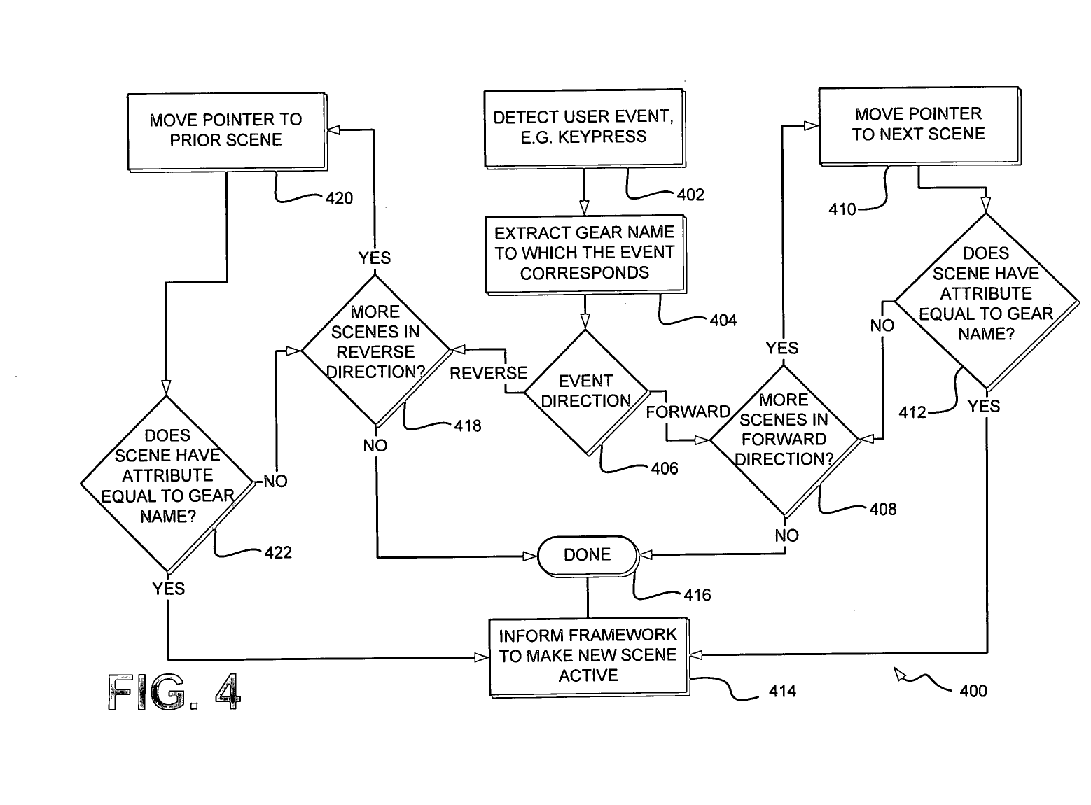

One implementation of an exemplary control framework 400 is depicted in the schematic diagram of FIG. 4. During playback of a graphical presentation, when a detection operation 402 detects a user navigation event, for example, depression of a navigation key through the UI, the control framework 400 in an extraction operation 404 extracts the gear name from the presentation order data file to which the navigation event corresponds. A decision operation 406 then determines which direction to move through the graphical presentation, i.e., whether the navigation event is a forward event or a reverse event.

If the navigation event is a forward event, the control framework 400 proceeds to a first query operation 408 to determine whether there are additional Scenes in the forward direction. If so, a movement operation 410 moves a pointer to the next group of frames collected as a Scene. If not, this indicates the present Scene is the last Scene in the graphical presentation and thus the graphical presentation is finished and the process is complete at the termination operation 416.

If there are additional Scenes in the forward direction, once the next Scene is identified in the movement operation 410, the control framework 400 examines the attributes associated with the Scene in the presentation order data file in a second query step 412. If the Scene has an attribute equivalent to the Gear name corresponding to the navigation event in the detection operation 402 (e.g., one or both of “nextscene” or “skipscene” are switched “on” for the Scene and correspond to the keystroke), then the control framework 400 instructs the presentation framework to consider the new Scene the active Scene and to begin playback of the new, active Scene. At this point the control framework 400 terminates in the termination operation 416 until a new navigation event is detected.

Alternately, if during the second query operation 412, the new Scene does not have an attribute corresponding to the navigation event, the control framework 400 returns to the first query 408 to determine whether or not there are additional Scenes in the forward direction. Depending upon the answer, the control framework 400 either continues to loop until a Scene has an appropriate attribute or the process terminates.

Returning to the decision operation 406, if the navigation event is a reverse event, the control framework 400 proceeds to a third query operation 4418 to determine whether there are additional Scenes in the reverse direction. If so, a movement operation 420 moves a pointer to the previous group of frames identified as a Scene. If not, this indicates the present Scene is the first Scene in the graphical presentation and thus the control framework process 400 is complete at the termination operation 416 until a new navigation event occurs.

If there are additional Scenes in the reverse direction, once the previous Scene is identified in the movement operation 420, the control framework 400 examines the attributes associated with the Scene in the presentation order data file in a fourth query step 422. If the Scene has an attribute equivalent to the gear name corresponding to the navigation event in the detection operation 402 (e.g., one or both of “nextscene” or “skipscene” are switched “on” for the Scene and correspond to the keystroke), then the control framework 400 instructs the presentation framework to consider the previous Scene the active Scene and to begin playback of the previous Scene. At this point the control framework 400 terminates in the termination operation 416 until a new navigation event is detected.

Alternately, if during the fourth query operation 422, the new Scene does not have an attribute corresponding to the navigation event, the control framework 400 returns to the third query 418 to determine whether or not there are additional Scenes in the reverse direction. Depending upon the answer, the control framework 400 either continues to loop until a Scene has an appropriate attribute or the process terminates.

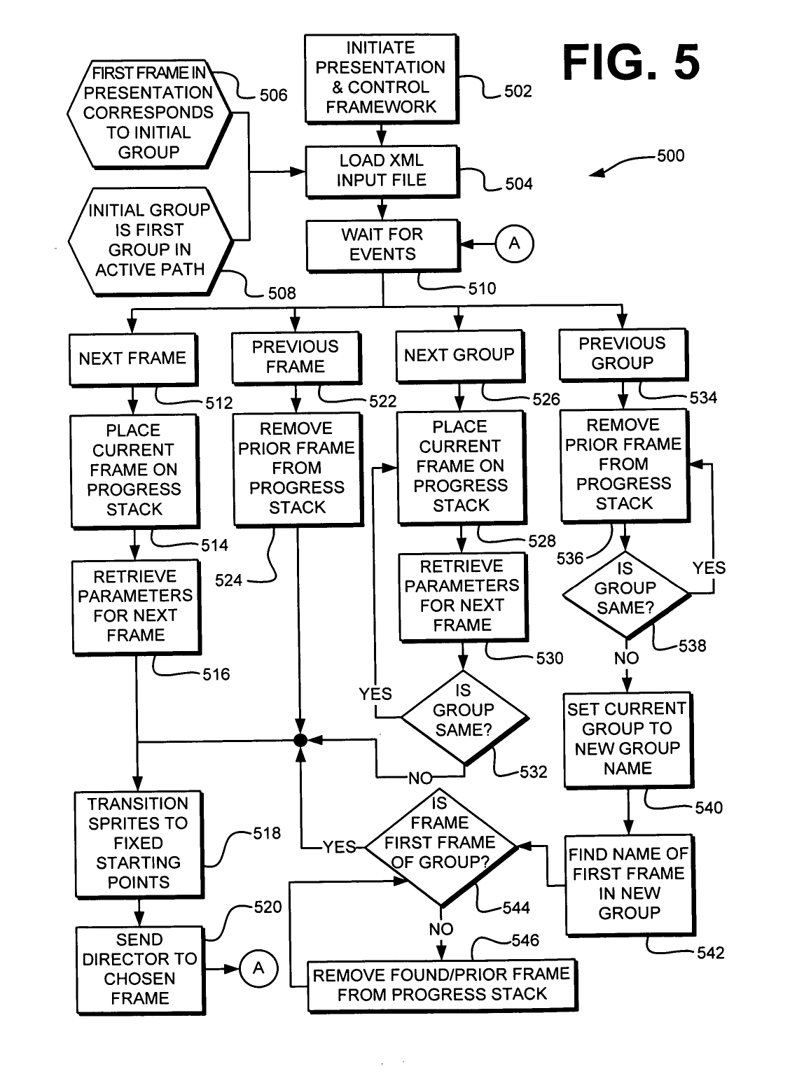

Another implementation of an exemplary control framework 500 is depicted in the schematic diagram of FIG. 5. When an initiation operation 502 begins a graphical presentation authored in a presentation creation program, the control framework 500 is simultaneously instantiated to provide additional control over the graphical presentation to a presenter. In a loading operation 504, the control framework 500 loads an XML file with meta information about the frames in the graphical presentation previously encoded. The XML file may have several initialization parameters. A first initialization parameter 506 may include a designation that the first frame in the graphical presentation is to be considered the first frame of a corresponding initial group of frames. A second initialization parameter 508 may include a designation that the initial group, previously defined with respect to the initial frame, is the first group of frames in what will be considered an initial active path.

Once the XML file is loaded with the appropriate initialization parameters set, the control framework process 500 enters into a waiting operation 510, wherein input operations of the computer system running the graphical presentation are monitored for commands by the presenter to change the order of the graphical presentation. Such input commands may include, for example, keystrokes on a keyboard, mouse clicks registered with a particular GUI control button, or remote control actuations.

In a normal operation of the graphical presentation, after each frame in the group is processed, the frame transitioning code will automatically advance to the next frame in the group. If the current frame is the last frame in the group, the presentation will pause until the user actuates an input command, for example, pressing the space bar, to advance to the next group in the path. However, the control framework may be designed to accept additional input commands to dynamically control the order of the graphical presentation. In an exemplary implementation as depicted in FIG. 5, these input commands may direct the control framework to perform one of several switching operations, for example, switch to the next frame 512, switch to the previous frame 522, switch to the next group 526, or switch to the previous group.

In the exemplary implementation of FIG. 5, the control framework creates a stack-based data structure for following the order of frames in the graphical presentation and determining the appropriate frame to which to transition. The stack may be a simple last-in-first-out progress stack; however, other data structures may alternatively be used. A frame may be represented as an object with the same properties as the frame elements in the XML file plus a group (e.g., a Scene) name of which the frame is a part. These objects are placed on the stack. When a next frame switching operation 512 is selected by a presenter, for example, by depressing a “right arrow” key on a keyboard, the control framework 500 performs a placing operation 514 places the current frame (i.e., a data object identifying the current frame and group, e.g., the Frame name or frameNum and Scene name in the exemplary XML implementation described above) on the top of the stack. This placing operation 514 is often termed a “push” operation, wherein a datum is put on top of the stack, increasing the stack size by one.

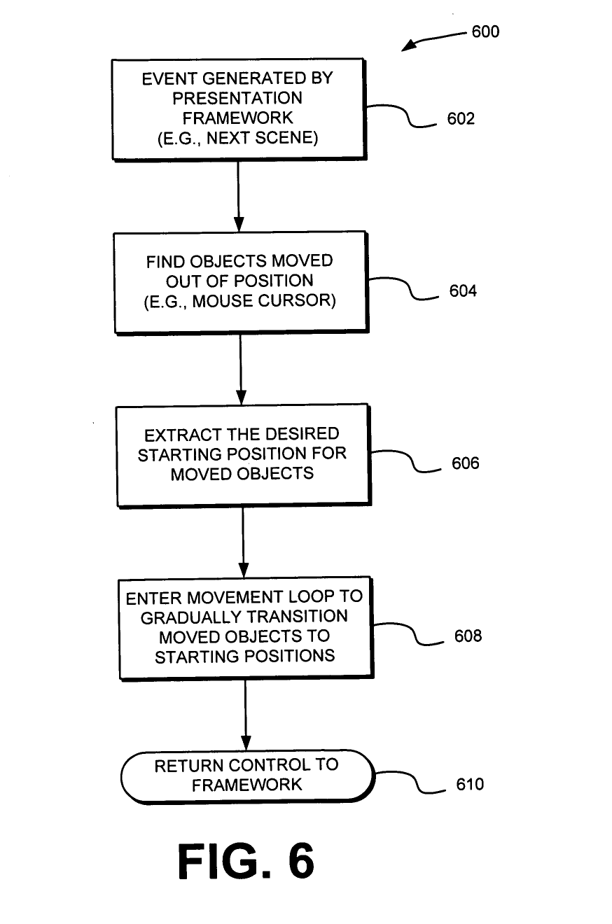

In a retrieving operation 516, the control framework 500 then retrieves parameters identifying the next frame from the XML file. The control framework 500 compares the positions of sprites common to the current frame and the next frame and, if necessary, in a transition operation 518 transitions the location of the sprites in the current frame to the starting position of the sprites for the next frame. This process is further described herein with respect to FIG. 6. Once any sprites have been transitioned to new starting positions comporting with the next frame, a sending operation 520 sends the viewer program to the next chosen frame, in this case, the next frame. For example, for a graphical presentation authored in Macromedia Director, the command “go ‘frame’” would be used to transition the graphical presentation from the current frame to the next frame by using the frameNum parameter for the next frame from the XML file. Once the viewer program begins presenting the next chosen frame, the control framework 500 returns to the waiting operation 510 to wait for additional events that may dynamically change the order of the graphical presentation.

Alternately, when the waiting operation 510 detects an input requesting a previous frame switching operation 512, for example, by a presenter depressing a “left arrow” key on a keyboard, the control framework 500 performs a removing operation 524 and removes the prior frame (i.e., a data object identifying the current frame and group, e.g., the Frame name or frameNum and Scene name in the exemplary XML implementation described above) from the top of the stack. This removing operation 514 is often termed a “pop” operation, wherein the top datum is taken from the stack, decreasing the stack size by one. It is possible that the current frame is the first frame of the graphical presentation. In this case the stack will become empty before finding a new frame. If this situation occurs, the frame selection is simply reset to the first frame.

The control framework 500 then compares the positions of sprites common to the current frame and the prior frame and, if necessary, in the transition operation 518 transitions the location of the sprites in the current frame to the starting position of the sprites for the prior frame as further described herein with respect to FIG. 6. Once any sprites have been transitioned to new starting positions comporting with the prior frame, a sending operation 520 sends the viewer program to the next chosen frame, in this case, the prior frame. For example, for a graphical presentation authored in Macromedia Director, the command “go ‘frame’” would be used to transition the graphical presentation from the current frame to the prior frame by using the frameNum parameter for the prior frame from the XML file. Once the viewer program begins presenting the next chosen frame, the control framework 500 returns to the waiting operation 510 to wait for additional events that may dynamically change the order of the graphical presentation.

When a next group switching operation 526 is selected by a presenter, for example, by depressing a “page down” key on a keyboard, the control framework 500 performs a placing operation 528 that places the current frame on the top of the stack. In a retrieving operation 530, the control framework 500 then retrieves parameters identifying the next frame from the XML file. In a comparison operation 532, the parameters of the next frame are compared to the current frame to determine whether both frames are part of the same group (e.g., a Scene as described in the exemplary XML implementation described above). If both frames are part of the same group, the next frame is reclassified as the current frame and the control framework 500 returns to the placing operation 528 to place the new current frame on the stack. The process iterates in this fashion until the comparison operation 532 identifies a next frame that is part of a different group than the current frame.

If the group associated with the next frame is new, the control framework 500 compares the positions of sprites common to the frame presented at the time the next group operation 526 was selected and the next frame. If necessary, a transition operation 518 transitions the location of one or more sprites in the current frame to the starting position of the sprites for the next frame. Once any sprites have been transitioned to new starting positions comporting with the next frame, a sending operation 520 sends the viewer program to the next chosen frame, in this case, the first frame of the next group. Once the viewer program begins presenting the next chosen frame, the control framework 500 returns to the waiting operation 510 to wait for additional events that may dynamically change the order of the graphical presentation.

When a previous group switching operation 534 is selected by a presenter, for example, by depressing a “page up” key on a keyboard, the control framework 500 performs a removing operation 536 and removes the prior frame from the top of the stack. In a comparison operation 538, the parameters of the prior frame are compared to the current frame to determine whether both frames are part of the same group. If both frames are part of the same group, the control framework returns to the removing operation 536 and removes a further prior frame from the stack. The process iterates in this fashion until the comparison operation 532 identifies a prior frame that is part of a different group than the current frame. As objects are removed from the progress stack, eventually a frame with a different group name than the current group will be found. It is possible that the current frame will be the first frame of the first group in which case the stack will become empty before finding a new group. In that case the current frame may be reset to the first frame.

If the scene associated with the prior frame is new, a setting operation 540 resets the parameter for the current group to store the new group name associated with the prior frame identified in the comparison operation 538. The control framework 500 next performs a finding operation 542 to locate the name of the first frame of the current group. A comparison operation 544 acts as a check on the finding operation 542 to determine whether the frame returned in the finding operation 542 is the first frame of the new group.

If the frame found is not the first frame of the new group, a removing operation 546 removes the found frame from the stack and the control framework 500 returns to the comparison operation 544 to determine whether the frame previous to the found frame is the first frame of the new group. If not, the frame previous to the found frame is removed from the stack. The process may iterate in this fashion until the comparison operation 544 determines that the found frame or a previous frame to the found frame is the first frame of the new group. This will maintain the integrity of the progress stack.

The control framework 500 then compares the positions of sprites common to the current frame presented at the time the previous group operation 534 was selected and the first frame of the new group. If necessary, a transition operation 518 transitions the location of one or more sprites in the current frame to the starting position of the sprites for the next frame. Once any sprites have been transitioned to new starting positions comporting with the next frame, a sending operation 520 sends the viewer program to the next chosen frame, in this case, the first frame of the previous scene. Once the viewer program begins presenting the next chosen frame, the control framework 500 returns to the waiting operation 510 to wait for additional events that may dynamically change the order of the graphical presentation.

FIG. 6 depicts an exemplary transition process 600 for transitioning the positions of sprites between one frame and another frame when a presenter, either through a path definition or dynamic input command, alters the position of sprites in a frame either directly or by changing the order of frames in a graphical presentation. In the context of FIG. 6, a transition between frames of different groups is represented. However, it should be understood that this transition process applies to transitions between any frames, either in the same or different groups or scenes.

Upon an event generation operation 602, which may be any navigation event in FIG. 4 or 5 that determines the next group to be presented, the control framework identifies the actors or sprites on the last frame of the prior group moved out of position in a finding operation 604. For example, a mouse cursor may be one of the sprites in the frame, but a presenter has used the UI to move the mouse cursor at the conclusion of the prior group or scene in order to illustrate a talking point.

Once the actors that have been moved are identified, an extraction operation 606 identifies the desired starting position on the stage in the first frame of the next group for the actors that have been moved. A transition operation 608 implements a movement loop to smoothly transition the positions of the moved actors from the position on the last frame of the prior group to the starting position on the first frame of the next group. Once the actors have transitioned to the starting position of the first frame of next group, in a returning operation 610 the control framework returns control to the presentation framework to play the next group in the graphical presentation.

In a simple example for transitioning a mouse cursor, upon receipt of a key input by a user to advance to the first frame of the next group, the control framework recognizes that a frame transition needs to occur and identifies the position of the mouse cursor. For example, in Macromedia Director specific frame properties define an X and Y position for an actor in a frame, e.g., the mouse cursor. This metadata from the frames allows the control framework to understand that the mouse needs to gracefully transition from its current position (any arbitrary position represented by position on the stage) to the starting point identified in the graphical presentation file for the first frame of the next group. A loop routine may then be actuated to smoothly animate movement of the mouse cursor from one position on the stage toward the starting point for the first frame of the next group until that point is reached.

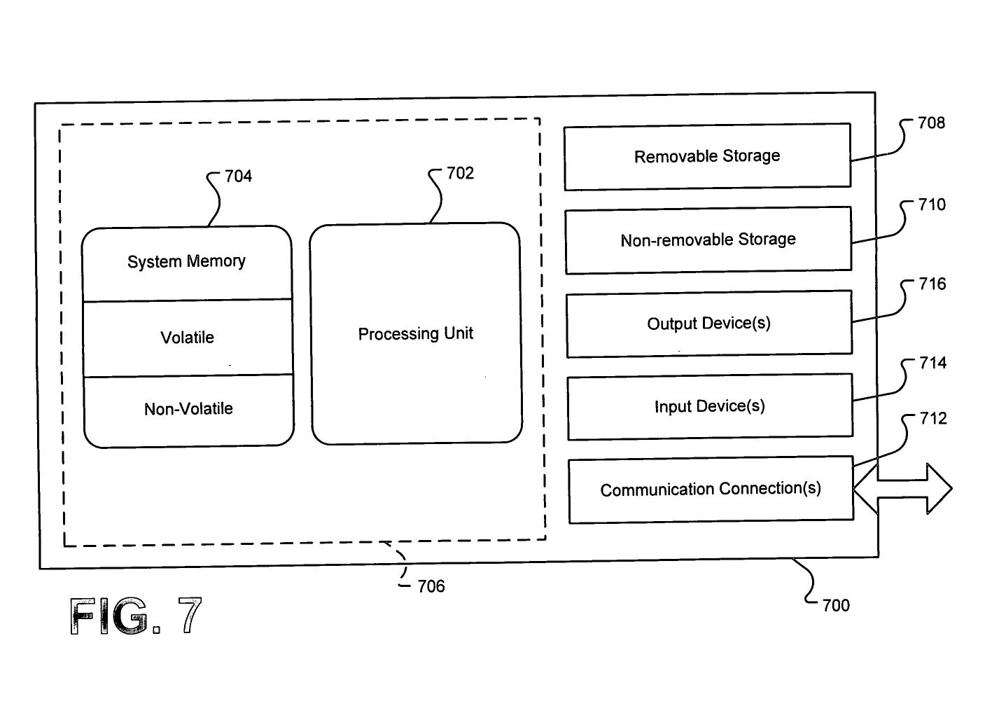

FIG. 7 illustrates an exemplary computer system 700 for operating the presentation creation and viewing programs, including the control framework, described herein. In one implementation, the computer system 700 may be embodied by a desktop computer, laptop computer, or application server computer, although other implementations, for example, video game consoles, set top boxes, portable gaming systems, personal digital assistants, and mobile phones may incorporate the described technology. The computer system 700 typically includes at least one processing unit 702 and memory 704. Depending upon the exact configuration and type of the computer system 700, the memory 704 may be volatile (e.g., RAM), non-volatile (e.g., ROM and flash memory), or some combination of both. The most basic configuration of the computer system 700 need include only the processing unit 702 and the memory 704 as indicated by the dashed line 706.

The computer system 700 may further include additional devices for memory storage or retrieval. These devices may be removable storage devices 708 or non-removable storage devices 710, for example, magnetic disk drives, magnetic tape drives, and optical drives for memory storage and retrieval on magnetic and optical media. Storage media may include volatile and nonvolatile media, both removable and non-removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the processing unit 702. Information, for example, XML files describing frame, group, scene, and path information for presentation frames may be stored on the storage media using any method or technology for storage of data, for example, computer readable instructions, data structures, and program modules.

The computer system 700 may also have one or more communication interfaces 712 that allow the system 700 to communicate with other devices. The communication interface 712 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 712 over the network via a modulated data signal, e.g., a carrier wave or other transport medium. A modulated data signal is an electromagnetic signal with characteristics that can be set or changed in such a manner as to encode data within the signal.

In some implementations, articles of manufacture, for example, a control framework, may be provided as computer program products. One implementation of a computer program product provides a computer program storage medium readable by the computer system 700 and encoding a computer program. Another implementation of a computer program product may be provided in a computer data signal embodied in a carrier wave by the computer system 700 and encoding the computer program.

The computer system 700 may further have a variety of input devices 714 and output devices 716. Exemplary input devices 714 may include a keyboard, a mouse, a tablet, a touch screen device, a scanner, a visual input device, and a microphone or other sound input device. Exemplary output devices 716 may include a display monitor, a printer, and speakers. Such input devices 714 and output devices 716 may be integrated with the computer system 700 or they may be connected to the computer system 700 via wires or wirelessly, e.g., via a Bluetooth protocol. These integrated or peripheral input and output devices are generally well known and are not further discussed herein. In one implementation, program instructions implementing the methods or the modules for implementing the control framework to control the graphical presentation, are embodied in the memory 704 and storage devices 708 and 710 and executed by processing unit 702. Other functions, for example, handling network communication transactions, may be performed by an operating system in the nonvolatile memory 704 of the computer system 700.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for controlling a graphical presentation composed of a plurality of frames in a default frame order, the method comprising
associating each of the plurality of frames in the graphical presentation with a respective frame identifier;
ordering at least one sequence of one or more of the plurality of frame identifiers in an alternative order to the default frame order; and
presenting one or more of the plurality of frames associated with the one or more of the plurality of frame identifiers in the at least one sequence in the alternative order.

2. The method of claim 1, wherein ordering operation further comprises
defining a plurality of sequences of one or more of the plurality of frame identifiers,
wherein the plurality of sequences is categorized in a plurality of respective groups; and
defining at least one path as a sequence of at least a subset of the plurality of groups; and
wherein the presenting operation further comprises presenting one or more of the plurality of frames associated with the one or more of the plurality of frame identifiers in the path.

3. The method of claim 1 further comprising creating a data file external to the graphical presentation wherein the data file contains each identifier corresponding to each of the plurality of frames and the at least one sequence.

4. The method of claim 1 further comprising invoking a frame access command within a presentation framework to perform the presenting operation.

5. The method of claim 1 further comprising
recognizing at least one input command; and
selecting the at least one sequence for presentation in the presenting operation based upon the at least one input command.

6. The method of claim 2 further comprising
recognizing at least one input command; and
selecting the at least one of the plurality of groups for presentation in the presenting operation based upon the at least one input command.

7. The method of claim 6 further comprising
defining at least one skip identifier;
associating the at least one skip identifier with the at least one path;
wherein upon recognition of the at least one input command, the skip identifier indicates a next group for selection by the selecting operation.

8. The method of claim 7, wherein the next group is immediately adjacent a prior group being presented at the time of recognition of the at least one input command in the sequence of the at least one path.

9. The method of claim 7, wherein the next group is not immediately adjacent a prior group being presented at the time of recognition of the at least one input command in the sequence of the at least one path.

10. The method of claim 7 further comprising
defining at least one direction identifier; and
associating the at least one direction identifier with the at least one path;
wherein upon recognition of the at least one input command, the direction identifier indicates whether the next group for selection by the selecting operation is located before or after a prior group being presented at the time of recognition of the at least one input command in the sequence of the at least one path.

11. The method of claim 6, wherein the at least one input command comprises a first input command and a second input command and
wherein the method further comprises
associating the first input command with a first group selection criteria; and
associating the second input command with a second group selection criteria;
wherein the first group selection criteria informs the selecting operation to select a first of the plurality of groups for presentation;
the second group selection criteria informs the selecting operation to select a second of the plurality of groups for presentation; and
the second of the plurality of groups is farther in advance of the first of the plurality of groups in the sequence defining the path.

12. The method of claim 1 further comprising imposing a control framework over the graphical presentation that executes the associating and ordering operations.

13. The method of claim 1, further comprising
identifying a first position of an actor on a stage in a current frame;
identifying a second position of the actor on the stage in a next frame according to the alternative order;
comparing the first position to the second position; and
transitioning the actor smoothly from the first position to the second position before the presentation of the next frame by the presenting operation if the first position and second position are not the same.

14. A computer-readable medium having computer-executable instructions for performing a computer process implementing the method of claim 1.

15. A method for repositioning an actor on a stage between frames in a graphical presentation, the method comprising
identifying a first position of the actor on the stage in a first frame;
identifying a second position of the actor on the stage in a second frame;
comparing the first position to the second position; and
transitioning the actor smoothly from the first position to the second position if the second position is not the same as the first position.

16. The method of claim 15, wherein the first position is a location to which the actor is manually relocated by a presenter after presentation of the first frame.

17. The method of claim 15 further comprising imposing a control framework over the graphical presentation that executes the transitioning operation.

18. A computer-readable medium having computer-executable instructions for performing a computer process implementing the method of claim 15.

19. A system for controlling a graphical presentation composed of a plurality of frames, wherein the graphical presentation is internally limited to following a default frame order, the system comprising
a memory that stores a data file comprising a plurality of identifiers corresponding respectively to each of the plurality of frames and a path that establishes an alternate arrangement of the plurality of identifiers to the default frame order;
a presentation framework that presents the graphical presentation;
a control framework that alters an order of presentation of the graphical presentation by the presentation framework from the default frame order to the alternate arrangement established by the path; and
a processor that implements instructions of the presentation framework and the control framework.

20. The system of claim 19 further comprising a user interface that receives an input command from a user that selects one of the plurality of identifiers; and wherein
the control framework further alters the order of presentation of the graphical presentation to present one of the plurality of frames corresponding to the selected one of the plurality of identifiers upon receipt of the input command.
